(19) United States
(12) Patent Application Publication
(10) Pub. No.: US 2010/0207085 A1
(43) Pub. Date: Aug. 19, 2010

(54) MOTORCYCLE LIFT

(76) Inventor: Kenneth R. Thurm, Orange, CA (US)

Correspondence Address: STETINA BRUNDA GARRED & BRUCKER, 75 ENTERPRISE, SUITE 250, ALISO VIEJO, CA, 92656, US

(21) Appl. No.: 12/389,129

(22) Filed: Feb. 19, 2009

(51) Int. Cl. B66F 9/065

(52) U.S. Cl. 254/2 C

(57) ABSTRACT

A motorcycle lift for use on a flat surface to lift and support a motorcycle, the lift comprising: a frame including a first longitudinal side, a second longitudinal side, a first longitudinal track, and a second longitudinal track; a first support and a second support disposable in a first position with a first support primary arm and a second support primary arm at an angle with the first longitudinal side and the second longitudinal side, respectively, the first support and the second support further disposable in a second position foldable on and resting parallel to the first longitudinal track and the second longitudinal track, respectively; a lift arm; a jack; and a first stabilizing arm assembly, a second stabilizing arm assembly, a third stabilizing arm assembly, and a fourth stabilizing arm assembly operative to stabilize the motorcycle lift.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a motorcycle lift for lifting and supporting motorcycles.

The support or lifting of a motorcycle off the ground is necessary to enable convenient and proper access for making repairs to or displaying the motorcycle. In the absence of a motorcycle lift, it may be more difficult to make needed repairs to the engine block and the surrounding area of the motorcycle, to replace and/or repair the motorcycle's front or rear wheel assemblies, or to otherwise view all aspects of the motorcycle. These repairs are therefore less time-consuming and may be more efficiently completed with the use of a motorcycle lift. Furthermore, a motorcycle may be better exhibited when it is displayed on a motorcycle lift.

The size and shape of motorcycle lifts are often bulky and cumbersome, making it more difficult to stow them in storage when not in use. Prior art motorcycle lifts also appear to have limitations in their ability to safely extend the lift supports beyond a certain height above the frame. These prior art lift systems also appear to have a reduced load bearing capacity. As a result of these limitations, access to all aspects of the motorcycle may be hindered, thereby impairing the ability to efficiently make needed repairs to the motorcycle. Also, these limitations may impair the ability to display or “showcase” the motorcycle more visibly.

Accordingly, there appears to be a need in the art for a new motorcycle lift for repairing or displaying a motorcycle.

### SUMMARY OF THE INVENTION

According to an aspect of the present invention, there is provided a motorcycle lift for use on a flat surface to lift and support a motorcycle. The motorcycle lift may include a frame. The frame may have a first longitudinal side and an opposing second longitudinal side. The frame may further have a first longitudinal track proximate to and spanning the length of the first longitudinal side. The frame may also have a second longitudinal track proximate to and spanning the length of the second longitudinal side.

The motorcycle lift may further include a first support operative to support and lift the motorcycle. The first support may have a first support first longitudinal side and an opposing first support second longitudinal side. The first support may also have a first support top surface disposed between the first support first longitudinal side and the first support second longitudinal side. The first support may further have a first support primary arm pivotally connected to the first support. The first support primary arm may be further pivotally connected to the first longitudinal track. The first support may be disposable in a first position with the first support primary arm at an angle greater than 0 degrees and less than or equal to 90 degrees with the first longitudinal side. The first support may be further disposable in a second position with the first support primary arm foldable on and resting parallel to the first longitudinal track.

The motorcycle lift may further include a second support operative to support and lift the motorcycle. The second support may have a second support first longitudinal side and an opposing second support second longitudinal side. The second support may also have a second support top surface disposed between the second support first longitudinal side and the second support second longitudinal side. The second support may further have a second support primary arm pivotally connected to the second support. The second support primary arm may be further pivotally connected to the second longitudinal track. The second support may be disposable in a first position with the second support primary arm at an angle greater than 0 degrees and less than or equal to 90 degrees with the second longitudinal side. The second support may be further disposable in a second position with the second support primary arm foldable on and resting parallel to the second longitudinal track.

The motorcycle lift is innovative because the first support primary arm and the second support primary arm are able to be folded onto and rested in a position parallel to the first longitudinal track and the second longitudinal track, respectively. This feature may enable the motorcycle to be conveniently and readily stored in the corner of garage, storage bin, or other convenient location when not in use, because the size and dimensions of the motorcycle lift may be significantly reduced. As a result, potential users who would have otherwise not had adequate space to stow a prior art motorcycle lift due to space restrictions may now be able to stow the motorcycle lift.

The motorcycle lift may further include a lift arm mechanically connected to the first support and the second support, operative to adjust the position of the first support and the second support.

The motorcycle lift may further include a jack operatively connected to the lift arm to adjust the height of the lift arm relative to the frame.

The motorcycle lift may further include a first stabilizing arm assembly. The first stabilizing arm assembly may include a first bracket mountable to the first longitudinal side, a first stabilizing arm disposable in the first bracket, and a first bracket hinge mountable to the first bracket operative to adjust the position of the first stabilizing arm. The first stabilizing arm may be disposable in a first position parallel to the first longitudinal side. The first stabilizing arm may be further disposable in a second position at an angle to the first longitudinal side.

The motorcycle lift may further include a second stabilizing arm assembly. The second stabilizing arm assembly may include a second bracket mountable to the first longitudinal side, a second stabilizing arm disposable in the second bracket, and a second bracket hinge mountable to the second bracket operative to adjust the position of the second stabilizing arm. The second stabilizing arm may be disposable in a first position parallel to the first longitudinal side. The second stabilizing arm may be further disposable in a second position at an angle to the first longitudinal side.

The motorcycle lift may further include a third stabilizing arm assembly. The third stabilizing arm assembly have a third bracket mountable to the second longitudinal side, a third stabilizing arm disposable in the third bracket, and a third bracket hinge mountable to the third bracket operative to adjust the position of the third stabilizing arm. The third stabilizing arm may be disposable in a first position parallel to the second longitudinal side. The third stabilizing arm may be further disposable in a second position at an angle to the second longitudinal side.

The motorcycle lift may further include a fourth stabilizing arm assembly. The fourth stabilizing arm assembly may include a fourth bracket mountable to the second longitudinal side, a fourth stabilizing arm. The fourth stabilizing arm may be disposable in a first position parallel to the second longitudinal side. The fourth stabilizing arm may be further disposable in a second position at an angle to the second longitudinal side.

These features of the motorcycle lift are innovative because the stabilizing arm assemblies, and in particular the stabilizing arms are able to widen the frame underlying the motorcycle lift. As a result of this widened stance, the center of gravity with the first support and second support extended may be raised, thereby enabling the height to which the first support and the second support may safely lift the motorcycle to be increased. With the frame of the motorcycle lift widened by the stabilizing arms, an increase in the extension of the first support and the second support relative to the frame may be accomplished without sacrificing the safety and balance of the motorcycle lift. The widening of the frame by the stabilizing arms reduces the risk of the motorcycle lift tipping over, thereby preventing potential injury to person or property. Because the first support and the second support may be extended to greater heights, this feature may provide improved and more convenient access to all parts of the motorcycle, for example when the motorcycle is undergoing repairs or an inspection. Another benefit resulting from the first support and the second support being raised to greater heights is that the motorcycle may be more visibly displayed or “showcased” to the public at exhibitions or in showrooms, thereby drawing more attention to the motorcycle. The widening of the frame by the stabilizing arms may also improve the load bearing capacity of the motorcycle lift, because the weight being supported or lifted by the motorcycle lift may be distributed across a greater area. As a result, the motorcycle lift may be able to lift and support heavier motorcycles undergoing repairs or inspection. This feature may also enable the motorcycle lift to display or “showcase” heavier motorcycles. An attractive promotional technique may also be employed by the motorcycle lift, namely allowing persons to sit on the motorcycle while it is lifted and supported by the motorcycle lift. With the hinge of the stabilizing arm assemblies enabling the stabilizing arms to be disposable in a second position that is at varying angles to the first longitudinal side or the second longitudinal side, the motorcycle lift may be adaptable to safely maintain its balance with the motorcycle place in different positions on the first support and the second support. That is, the resulting center of mass of the motorcycle depending on the position of the engine block, wheel assembly, and front wheel assembly on the motorcycle lift may nonetheless be accommodated by the motorcycle lift with the adjustment of the stabilizing arms relative to the first longitudinal side and the second longitudinal side. This feature uniquely gives the user the flexibility to select how they want to position the motorcycle on the first support and the second support during the repair and/or display of the motorcycle. The ability of the motorcycle lift to safely stabilize the frame with the stabilizing arms may improve the efficiency of making repairs to the motorcycle or in being able to “showcase” the desired features of the motorcycle while on display.

In another embodiment, the frame may have a first lateral side and an opposing second lateral side. The first lateral side and the second lateral side may be disposed generally between the first longitudinal side and the second longitudinal side.

In another embodiment, the first support may have a first support primary arm first end connectible to the first support. The first support may further have a first support primary arm second end connectible to the first longitudinal track.

In yet a further embodiment, the second support may have a second support primary arm first end connectible to the second support. The second support may further have a second support primary arm second end connectible to the second longitudinal track.

According to another embodiment, the lift arm may have a lift arm first end connectible to the first support operative to adjust the position of the first support. The lift arm may further have a lift arm second end connectible to the second support operative to to adjust the position of the second support.

In yet a further embodiment, the jack may have a jack first end connectible to the lift arm. In yet another embodiment, the jack used on the motorcycle lift may be a hydraulic jack. In another embodiment, the jack may be a pneumatic jack.

According to another embodiment, the motorcycle lift may further include a first support secondary arm. The first support secondary arm may have a first support secondary arm first end mountable to the first support. The first support secondary arm may further have a first support secondary arm second end mountable to the first longitudinal track.

According to another embodiment, the motorcycle lift may further include a second support secondary arm. The second support secondary arm may have a second support secondary arm first end mountable to the second support. The second support secondary arm may further have a second support secondary arm second end mountable to the second longitudinal track.

In yet a further embodiment, the motorcycle lift may further include a first extension having a first extension first end and a first extension second end. The first extension first end may be mountable to the lift arm first end.

In another embodiment, the motorcycle lift may further include a second extension having a second extension first end and a second extension second end. The second extension first end may be mountable to the lift arm second end.

In another embodiment, the motorcycle life may further include a first mounting plate having a first mounting plate first end and a first mounting plate second end. The first mounting plate first end may be connectible to the first extension second end and the first support primary arm. The first mounting plate second end may be connectible to the first longitudinal track. The first mounting plate may have a plurality of grooves connectible to the first extension second end operative to adjust the position of the first support primary arm.

In yet another embodiment, the motorcycle lift may further include a second mounting plate having a second mounting plate first end and a second mounting plate second end. The second mounting plate first end may be connectible to the second extension second end and the second support primary arm. The second mounting plate second end may be connectible to the second longitudinal track. The second mounting plate may have a plurality of grooves connectible to the second extension second end operative to adjust the position of the second support primary arm.

According to another embodiment, the motorcycle lift may further include a handle mountable to the lift arm operative to pull the motorcycle lift.

The motorcycle lift may further include a first stabilizing crossbar disposable between the first longitudinal track and the second longitudinal track. The jack be mountable to the first stabilizing crossbar at a jack second end. The motorcycle lift may further include a second stabilizing crossbar disposable between the first longitudinal track and the second longitudinal track. The motorcycle lift may further include a third stabilizing crossbar disposable between the first longitudinal track and the second longitudinal track.

According to another embodiment, the motorcycle lift may further include a first longitudinal track wheel disposable in the first longitudinal track proximate to the second lateral side. The motorcycle lift may further include a second longitudinal track wheel disposable in the second longitudinal track proximate to the second lateral side. The first longitudinal track wheel and the second longitudinal track wheel may be operative to roll the motorcycle lift on the flat surface.

In yet another embodiment, the motorcycle lift may further include a first rear wheel mountable to the first lateral side and proximate to the first longitudinal track. The motorcycle lift may further include a second rear wheel mountable to the first lateral side and proximate to the second lateral track. The first rear wheel and the second rear wheel may be operative to roll the motorcycle lift on the flat surface.

This feature of the motorcycle lift is innovative in that it enables the motorcycle lift to be conveniently moved throughout a garage for repairs or in a showroom to display the motorcycle.

According to another embodiment, the motorcycle lift may further include a stabilizing adjuster disposable on the distal end of each of the first stabilizing arm, the second stabilizing arm, the third stabilizing arm, and the fourth stabilizing arm. The stabilizing adjuster may be operative to adjust the position of each of the first stabilizing arm, the second stabilizing arm, the third stabilizing arm, and the fourth stabilizing arm on the flat surface.

This feature of the motorcycle lift is innovative in that it enables the stabilizing arms to be precisely positioned on the flat surface to safely stabilize the motorcycle lift relative to how the motorcycle has been positioned on the first support and the second support. As discussed above, the stabilizing arms may be uniquely adjusted to safely balance the weight of the motorcycle lift and the motorcycle thereon.

### BRIEF DESCRIPTION OF THE DRAWINGS

These and other features are advantages of the various embodiments disclosed herein that will be better understood with respect to the following description and drawings, in which like number refer to like parts throughout, and in which:

FIG. 1 is a perspective view of an embodiment of the motorcycle lift with the first support and the second support disposed in a first position and the first stabilizing arm, the second stabilizing arm, the third stabilizing arm, and the fourth stabilizing arm in a second position approximately perpendicular to the first longitudinal side and the second longitudinal side, respectively;

FIG. 2 is a top view of an embodiment of the motorcycle lift with the first support and the second support disposed in a first position and the first stabilizing arm, the second stabilizing arm, the third stabilizing arm, and the fourth stabilizing arm in a second position approximately perpendicular to the first longitudinal side and the second longitudinal side, respectively;

FIG. 3 is a side view of an embodiment of the motorcycle lift with the first support and the second support disposed in a first position and the first stabilizing arm, the second stabilizing arm, the third stabilizing arm, and the fourth stabilizing arm in a second position approximately perpendicular to the first longitudinal side and the second longitudinal side, respectively;

FIG. 4 is a bottom view of an embodiment of the motorcycle lift with the first support and the second support disposed in a first position and the first stabilizing arm, the second stabilizing arm, the third stabilizing arm, and the fourth stabilizing arm in a second position approximately perpendicular to the first longitudinal side and the second longitudinal side, respectively;

FIG. 5 is a rear view of an embodiment of the motorcycle lift with the first support and the second support disposed in a first position and the first stabilizing arm, the second stabilizing arm, the third stabilizing arm, and the fourth stabilizing arm in a second position approximately perpendicular to the first longitudinal side and the second longitudinal side, respectively;

FIG. 6 is a frontal view of an embodiment of the motorcycle lift with the first support and the second support disposed in a first position and the first stabilizing arm, the second stabilizing arm, the third stabilizing arm, and the fourth stabilizing arm in a second position approximately perpendicular to the first longitudinal side and the second longitudinal side, respectively;

FIG. 7 is a perspective view of an embodiment of the motorcycle lift with the first support and the second support disposed in a second position folded on and resting substantially parallel to the first longitudinal track and the second longitudinal track, respectively, and the stabilizing arms disposable in a first position approximately parallel to the first longitudinal side and the second longitudinal side, respectively;

FIG. 8 is a top view of an embodiment of the motorcycle lift with the first support and the second support disposed in a second position folded on and resting substantially parallel to the first longitudinal track and the second longitudinal track, respectively;

FIG. 9 is a side view of an embodiment of the motorcycle lift with the first support and the second support disposed in a second position folded on and resting substantially parallel to the first longitudinal track and the second longitudinal track, respectively, and the stabilizing arms disposable in a first position approximately parallel to the first longitudinal side and the second longitudinal side, respectively; and

FIG. 10 is a rear view of an embodiment of the motorcycle lift with the first support and the second support disposed in a second position folded on and resting substantially parallel to the first longitudinal track and the second longitudinal track, respectively.

### DETAILED DESCRIPTION

The drawings referred to herein are for the purposes of illustrating the preferred embodiments of the present invention and not for the purposes of limiting the same.

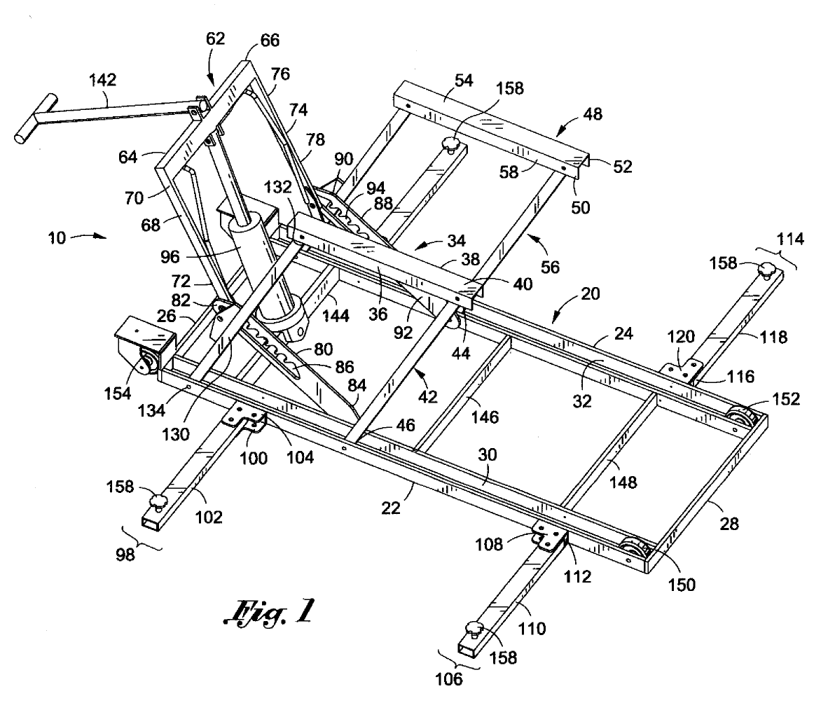

FIG. 1 is an embodiment of a motorcycle lift 10 positioned on a flat surface 11 to lift and support a motorcycle 12. A first support 34 and a second support 48 are depicted in a first position with a first support primary arm 42 and a second support primary arm 56 at an angle to a first longitudinal side 22 and a second longitudinal side 24 of a frame 20, respectively. The first support 34 may have a first support first longitudinal side 36 and an opposing first support second longitudinal side 38. The first support 34 may further have a first support top surface 40 disposed between the first support first longitudinal side 36 and the first support second longitudinal side 38. In the embodiment depicted in FIG. 1, the first support 34 may have a first support primary arm 42 and a first support secondary arm 130 pivotally connected to the first support 34 and operative to enable the first support 34 to support and lift the motorcycle 12. The first support primary arm 42 may also be pivotally connected to a first longitudinal track 30. In one embodiment, the first support primary arm 42 may have a first support primary arm first end 44 mountable to the first support 34. The first support primary arm 42 may also have a first support primary arm second end 46 mountable to the first longitudinal track 30 proximate to and spanning the length of the first longitudinal side 22. The first support secondary arm 130 may have a first support secondary arm first end 132 mountable to the first support 34. The first support secondary arm 130 may also have a first support secondary arm second end 134 mountable to the first longitudinal track 30 on the frame 20. However, in other embodiments of the motorcycle lift 10, the first support 34 may only have a first support primary arm 42 pivotally connected to the first support 34, without a first support secondary arm 130.

The second support 48 may have a second support first longitudinal side 50 and an opposing second support second longitudinal side 52. The second support 48 may further have a second support top surface 54 disposed between the second support first longitudinal side 50 and a second support second longitudinal side 52. The second support primary arm 56 may also have a second support primary arm second end 60 mountable to the second longitudinal track 32. In the embodiment in FIG. 1, the second support 48 has a second support primary arm 56 and a second support secondary arm 136 pivotally connected to the second support 48 and operative to enable the second support 48 to support and lift the motorcycle 12. The second support primary arm 56 may also be pivotally connected to a second longitudinal track 32 proximate to and spanning the length of the second longitudinal side 24. In one embodiment, the second support primary arm 56 may have a second support primary arm first end 58 mountable to the second support 48. The second support primary arm 56 may also have a second support primary arm second end 60 mountable to the second longitudinal track 32. The second support secondary arm 136 may have a second support secondary arm first end 138 mountable to the second support 48. The second support secondary arm 136 may also have a second support secondary arm second end 140 mountable to the second longitudinal track 32 on the frame 20. However, in other embodiments of the motorcycle lift 10, the second support 48 may only have a second support primary arm 56 pivotally connected to the second support 48, without a second support secondary arm 136.

The frame 20 may include a first longitudinal side 22 and an opposing second longitudinal side 24. In one embodiment, the frame 20 may further include a first lateral side 26 and an opposing second lateral side 28. The first lateral side 26 and the second lateral side 28 may be disposed generally between the first longitudinal side 22 and the second longitudinal side 24.

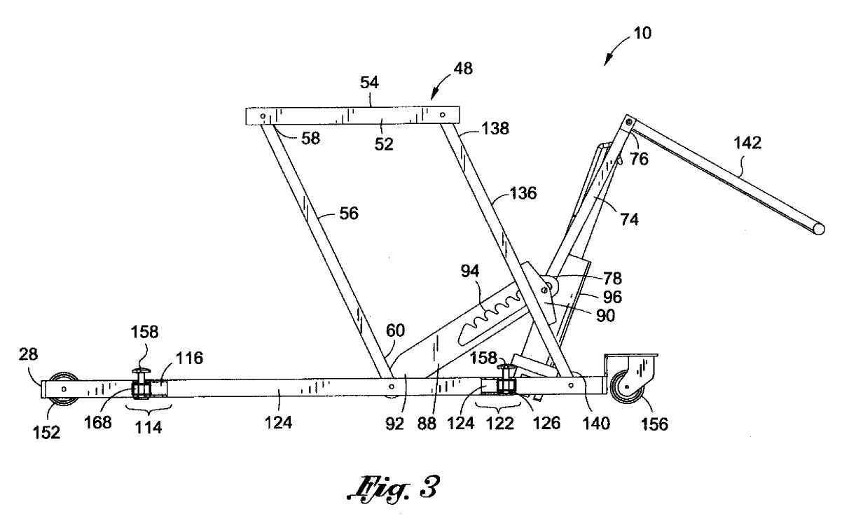

With the first support 34 and the second support 48 disposed in a first position as depicted in FIG. 1, the first support primary arm 42 and the first support secondary arm 130 may be at an angle of approximately 80 degrees with the first longitudinal side 22. However, it is also contemplated that in other embodiments, the first support primary arm 42 and the first support secondary arm 130 may be at an angle greater than 0 degrees and less than or equal to 90 degrees with the first longitudinal side 22, with the first support 34 disposed in the first position. In the embodiment depicted in FIG. 3, the second support primary arm 56 and the second support secondary arm 136 may be at an angle of approximately 80 degrees with the second longitudinal side 24 in the first position. As with the first support 34, it is also contemplated that in other embodiments, the second support primary arm 56 and the second support secondary arm 136 may be at an angle greater than 0 degrees and less than or equal to 90 degrees with the second longitudinal side 24, with the second support 48 disposed in the first position.

This feature is innovative because the motorcycle lift 10 may be conveniently and readily stored because of its reduced bulk and size with the first support 34 and the second support 48 folded on and resting parallel to the first longitudinal track 30 and the second longitudinal track 32, respectively. Because the motorcycle lift 10 takes up less space with the first support 34 and the second support 48 in the second position, it may be stowed for example in the corner of a garage, closet, or other convenient space. As such, users who would have otherwise not had sufficient space to stow the motorcycle lift 10 may now be able to do so when the motorcycle lift 10 is not in use, with the first support 34 and the second support 48 folded in the second position.

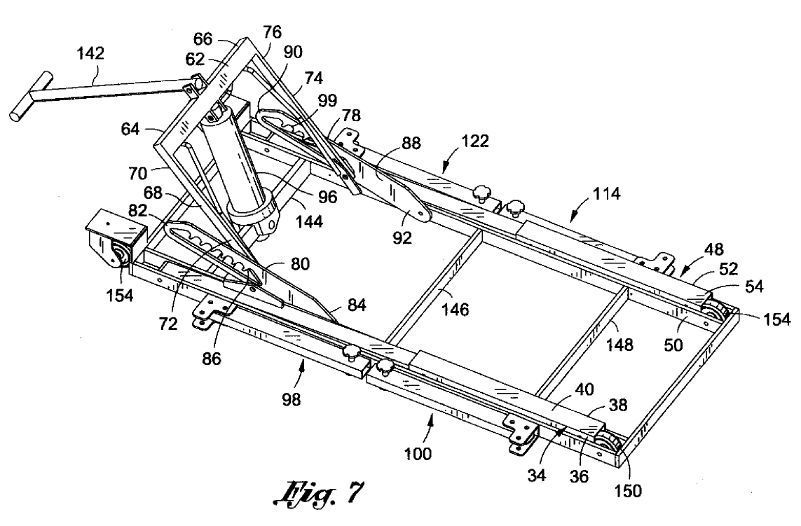

Referring to the embodiment depicted in FIG. 7, the motorcycle lift 10 is shown disposable in a second position with the first support primary arm 42 and the first support secondary arm 130 foldable on and resting parallel to the first longitudinal track 30. In this embodiment, the first support 34 is also foldable on and rests parallel to the first longitudinal track 30. In the second position, the second support primary arm 56 and the second support secondary arm 136 also folds on and rests parallel to the second longitudinal track 32. In this embodiment, the second support 48 is also foldable on and rests parallel to the second longitudinal track 32.

In the embodiment depicted in FIG. 1, the motorcycle lift 10 may have a lift arm 62 mechanically connected to the first support 34 and the second support 48. In another embodiment, the lift arm 62 may have a lift arm first end 64 and an opposing lift arm second end 66. The lift arm first end 64 may be connectible to the first support 34 and operative to adjust the position of the first support 34. The lift arm second end 66 may be connectible to the second support 48 and operative to adjust the position of the second support 48. In yet another embodiment, a first extension 68 may be mountable to the lift arm first end 64 at a first extension first end 70. A second extension 74 may be mountable to the lift arm second end 66 at a second extension first end 76. According to another embodiment, the first extension 68 may also have a first extension second end 72 that is mountable to a first mounting plate 80 at a first mounting plate first end 82. The second extension 74 may also have a second extension second end 78 that is mountable to a second mounting plate 88 at a second mounting plate first end 90. The first mounting plate 80 may further have a first mounting plate second end 84 connectible to the first longitudinal track 30. The first mounting plate 80 may also have a plurality of grooves 86 connectible to the first extension second end 72 operative to adjust the position of the first support primary arm 42 relative to the frame 20. Likewise, as shown in the embodiment in FIG. 1, the second mounting plate 88 may also have a second mounting plate second end connectible to the second longitudinal track 32. The second mounting plate 88 may further have a plurality of grooves 94 connectible to the second extension second end 78 operative to adjust the position of the second support primary arm 56 relative to the frame 20.

As depicted in the embodiment in FIG. 7, with the first support 34 and the second support 48 in the second position, the first extension second end 72 is disposed into the groove 86 on the first mounting plate 80 closest to the first mounting plate second end 84. Likewise, with the second support 48 in the second position, the second extension second end 78 is disposed into the groove 94 of the second mounting plate 88 closest to the second mounting plate second end 92. As discussed above, if a motorcycle 12 is not being supported and/or lifted by the motorcycle lift 10, the second position enables the motorcycle lift 10 to be conveniently stowed when not in use.

In the embodiment depicted in FIG. 1, the motorcycle lift 10 may further include a jack 96 connectible to the lift arm 62 at a jack first end 97 and operative to adjust the height of the lift arm 62. The complete extension of the jack 96 enables the first support 34 and the second support 48 to be extended above the frame 20 in the first position. With the first support 34 and the second support 48 folded on and resting parallel to the first longitudinal track 30 and the second longitudinal track 32, the jack 96 may be compressed. In another embodiment, the jack may be a hydraulic jack. The hydraulic jack may be manually operated. In another embodiment, the hydraulic jack may be motorized. In yet another embodiment, the jack may be an air over hydraulic jack. The air over hydraulic jack may be operated by an air lever.

The embodiment of the motorcycle lift 10 depicted in FIG. 1 also includes a first stabilizing arm assembly 98 having a first bracket 100 mountable to the first longitudinal side 22 of the frame 20. A first bracket hinge 104 is mountable to the first bracket 100. A first stabilizing arm 102 is disposed in the first bracket hinge 104. The first bracket hinge 104 is operative to adjust the position of the first stabilizing arm 102 parallel to the first longitudinal side 22 in a first position and at an angle to the first longitudinal side 22 in a second position. In the embodiment depicted in FIG. 1, a second stabilizing arm assembly 106 includes a second bracket 108 mountable to the first longitudinal side 22 of the frame 20. A second bracket hinge 112 is mountable to the second bracket 108. A second stabilizing arm 110 is disposed in the second bracket hinge 112. The second bracket hinge 112 is operative to adjust the position of the second stabilizing arm 110 parallel to the first longitudinal side 22 in a first position and at an angle to the first longitudinal side 22 in a second position. The embodiment depicted in FIG. 1 also includes a third stabilizing arm assembly 114 having a third bracket 116 mountable to the second longitudinal side 24 of the frame 20. A third bracket hinge 120 is mountable to the third bracket 116 operative to adjust the position of the third stabilizing arm 114 parallel to the second longitudinal side 24 in a first position and at an angle to the second longitudinal side 24 in a second position. The embodiment of the motorcycle lift 10 may also include a fourth stabilizing arm assembly 122 having a fourth bracket 124 mountable to the second longitudinal side 24 of the frame 20. A fourth bracket hinge 128 is mountable to the fourth bracket 124. A fourth stabilizing arm 126 is disposed in the fourth bracket hinge 128. The fourth bracket hinge 128 is operative to adjust the position of the fourth stabilizing arm 126 parallel to the second longitudinal side 24 in a first position and at an angle to the second longitudinal side 24 in a second position.

The first stabilizing arm assembly 98, the second stabilizing arm assembly 106 the third stabilizing arm assembly 114, and the fourth stabilizing arm assembly 122 are all adjustable to safely stabilize the weight of the motorcycle lift 10 on the flat surface 11. This feature is innovative because the first stabilizing arm 102, the second stabilizing arm 110, the third stabilizing arm 118, and the fourth stabilizing arm 126 effectively widen the frame 20 underlying the motorcycle lift 10. As a result, the first support 34 and the second support 48 are extendable to a greater height above the frame 20 without sacrificing the safe balancing of the motorcycle lift 10. The widening of the frame 20 by the stabilizing arms enables the motorcycle lift 10 to accommodate the higher center of gravity resulting from the lengthening of the first support primary arm 42 and the second support primary arm 56. As a result, the motorcycle 12 may be safely raised on the first support 34 and the second support 48 a greater height above the frame 20 than prior art lifts could safely achieve. Accordingly, there is less risk of the motorcycle lift 10 tipping over and causing injury to person or property. With the motorcycle lift 10 able to safely extend the first support 34 and the second support 48 to greater heights, the user may be provided with improved and more convenient access to all parts of the motorcycle 12. This feature is most advantageous when making repairs to the motorcycle 12 while it is on the motorcycle lift 10, or for achieving better visibility of the motorcycle 12 as it is displayed or “showcased” at exhibitions or in showrooms. The widening of the frame 20 by the first stabilizing arm 102, the second stabilizing arm 110, the third stabilizing arm 118, and the fourth stabilizing arm 126 may also improve the load bearing capacity of the motorcycle lift 10, because there is a distribution of the weight of the motorcycle lift 10 and the motorcycle 12 across a greater area. Therefore, this feature enables the motorcycle lift 10 to lift and support heavier bikes either for repairs or display of the motorcycle 12. With this increased load bearing capacity, the motorcycle lift 10 may also be able to accommodate the weight of both the motorcycle 12 and a person, thereby enabling a unique promotional display.

The first stabilizing arm 102, the second stabilizing arm 110, the third stabilizing arm 118, and the fourth stabilizing arm 126 are parallel to the first longitudinal side 22 and the second longitudinal side 24, respectively, in their first position. As discussed above, the reduced bulk and dimension of the motorcycle lift 10 may uniquely enable the convenient storage of the motorcycle lift 10 when it is not in use. In their second position, the first stabilizing arm 102, the second stabilizing arm 110, the third stabilizing arm 118, and the fourth stabilizing arm 126 are adjustable to form an angle with the first longitudinal side 22 and the second longitudinal side 24 greater than 0 degrees and less than 180 degrees. In the embodiment in FIG. 1, the first stabilizing arm 102 and the second stabilizing arm 110 are at an angle to the first longitudinal side 22 of approximately 90 degrees. Likewise, the third stabilizing arm 118 and the fourth stabilizing arm 126 are at an angle to the second longitudinal side 24 of approximately 90 degrees. Depending on how the motorcycle 12 is positioned on the first support 34 and the second support 48 of the motorcycle lift 10, the position of the stabilizing arms may be adjusted to safely support the weight of the motorcycle lift 10 and the motorcycle 12. For example, if a repair requires the motorcycle 12 to be positioned on the motorcycle lift 10 such that its engine block is more visible, the stabilizing arms may be adjusted to accommodate a shift in the center of mass of the motorcycle 12 as it rests on the motorcycle lift 10. Likewise, if a particular feature of the motorcycle 12 is sought to be emphasized while on display, the stabilizing arms may safely accommodate a repositioning of the motorcycle 12 on the motorcycle lift 10 without sacrificing the safe balancing of the motorcycle 12. As shown in FIGS. 1 and 7, the first bracket hinge 104, the second bracket hinge 112, the third bracket hinge 120, and the fourth bracket hinge 128 enable each of the first stabilizing arm 102, the second stabilizing arm 110, the third stabilizing arm 118, and the fourth stabilizing arm 126 to be adjustable from a parallel to a perpendicular position with the first longitudinal side 22 and the second longitudinal side 24, respectively. In the embodiment depicted in FIG. 1, the motorcycle lift 10 may also include a handle 142 mountable to the lift arm 62. The handle 142 may be operative to pull the motorcycle lift 10 along the flat surface 11, thereby enabling the motorcycle lift 10 to be readily transportable across a garage or showroom.

Still referring to FIG. 1, in another embodiment, the motorcycle lift 10 may further include a first stabilizing crossbar 144 disposable between the first longitudinal track 30 and the second longitudinal track 32 of the frame 20. The first stabilizing crossbar 144 may be operative to further stabilize the motorcycle lift 10 on the flat surface 11. In the embodiment depicted in FIG. 1, the jack 96 may be mountable to the first stabilizing crossbar 144 at a jack second end 95. In another embodiment, the motorcycle lift 10 may also include a second stabilizing crossbar 146 disposable between the first longitudinal track 30 and the second longitudinal track 32 of the frame 20. The second stabilizing crossbar 146, together with the first stabilizing crossbar 144, may be operative to further stabilize the motorcycle lift 10. In the embodiment depicted in FIG. 1, the motorcycle lift 10 also includes a third stabilizing crossbar 148 disposable between the first longitudinal track 30 and the second longitudinal track 32. The third stabilizing crossbar 148 may likewise provide further stability to the frame 20 and the motorcycle lift 10.

In the embodiment depicted in FIG. 1, the motorcycle lift 10 may also include a stabilizing adjuster 158 disposable on the distal end of each of the first stabilizing arm 102, the second stabilizing arm 110, the third stabilizing arm 118, and the fourth stabilizing arm 126. The stabilizing adjuster 158 may be operative to further adjust and secure the position of each of the first stabilizing arm 102, the second stabilizing arm 110, the third stabilizing arm 118, and the fourth stabilizing arm 122 on the flat surface 11. This feature in addition to those described above may improve the safety and balance of the motorcycle lift 10 so that the motorcycle 12 does not fall off the first support 34 and the second support 48 while the motorcycle 12 is undergoing repairs or being displayed.

In the embodiment depicted in FIG. 1, the motorcycle lift 10 may further include a first longitudinal track wheel 150 disposable in the first longitudinal track 30 proximate to the second lateral side 28. In this embodiment, the motorcycle lift 10 may also include a second longitudinal track wheel 152 disposable in the second longitudinal track 32 proximate to the second lateral side 28. The first longitudinal track wheel 150 and the second longitudinal track wheel 152 are operative to enable the motorcycle lift 10 to be rolled on the flat surface 11. In another embodiment, the motorcycle lift 10 may further include a first rear wheel 154 mountable to the first lateral side 26 and proximate to the first longitudinal track 30. The motorcycle lift 10 may also include a second rear wheel 156 mountable to the first lateral side 26 and proximate to the second longitudinal track 32. The first rear wheel 154 and the second rear wheel 156 may be operative to further enable the motorcycle lift 10 to be rolled on the flat surface 11. These features may uniquely enable the motorcycle lift 10 to be conveniently and efficiently pulled by the handle 142 across a garage or showroom floor.

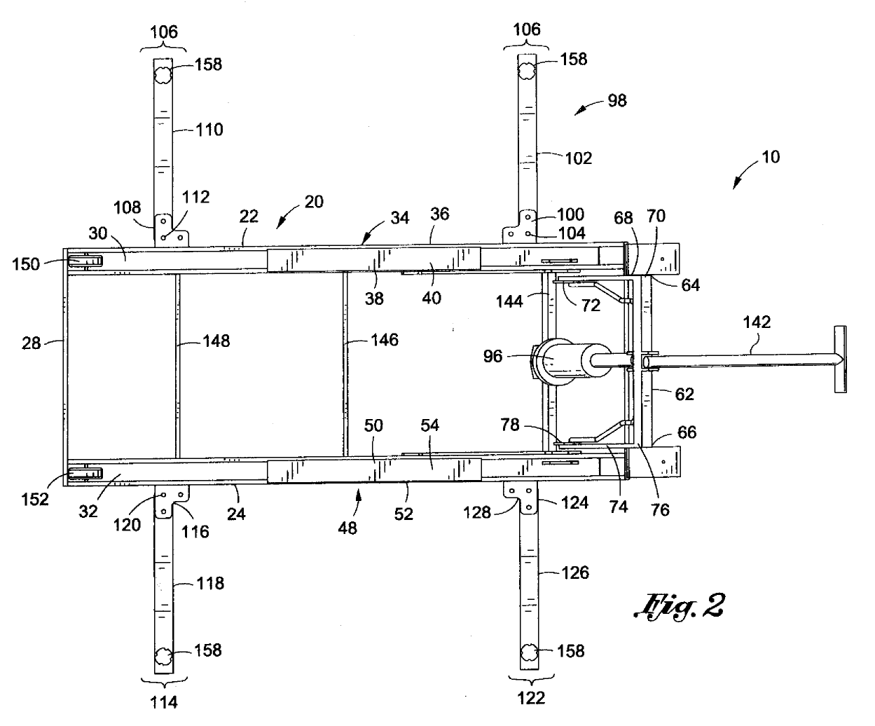

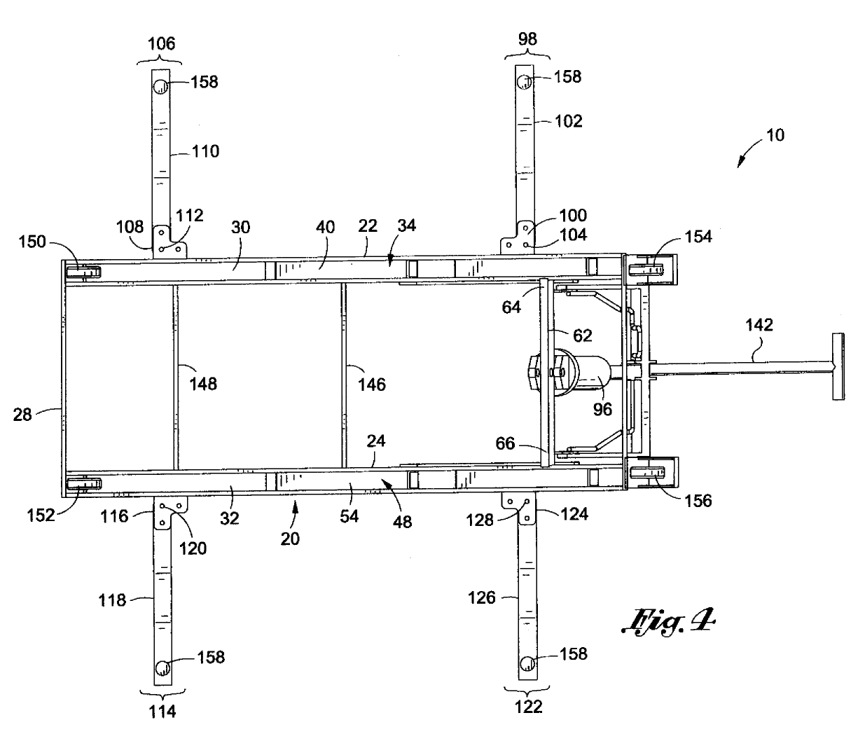

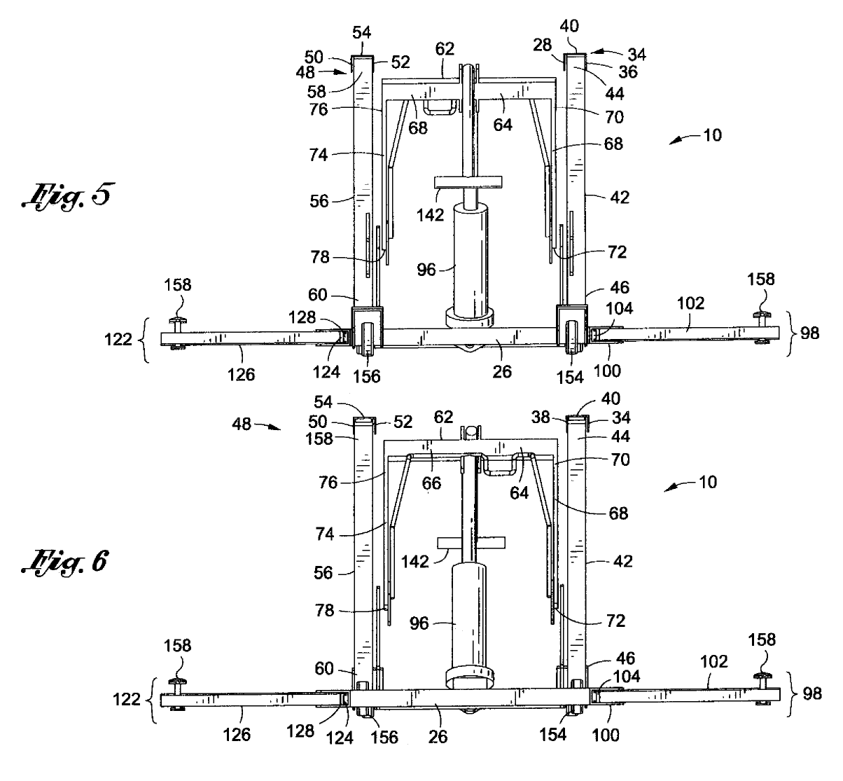

FIGS. 2-6 are various views of an embodiment of the motorcycle lift 10 including the first support 34 and the second support 48 disposed in the first position. The first support primary arm 44, the first support secondary arm 130, the second support primary arm 56, and the second support secondary arm 136 are all shown extended in the first position at an angle of approximately 80 degrees to the first longitudinal side 22 and the second longitudinal side 24, respectively. The first stabilizing arm 102, the second stabilizing arm 110, the third stabilizing arm 118, and the fourth stabilizing arm 126 are each shown extended and perpendicular to the first longitudinal side 22 and the second longitudinal side 24, respectively.

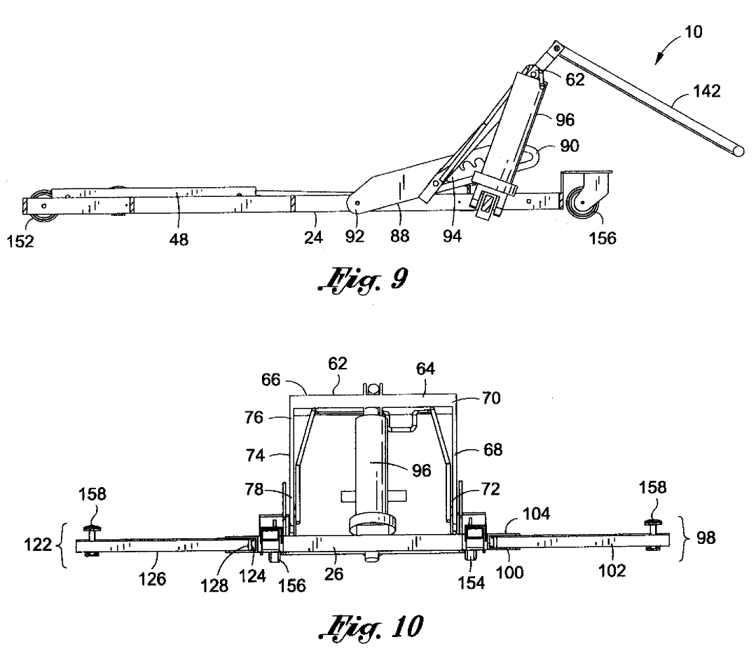

Referring to FIGS. 1, the first support 34 may be in the first position with the first extension second end 72 deployed in any one of the grooves 86 located on the first mounting plate 80 with one exception. With the first extension second end 72 deployed in the groove 86 closest to the first mounting plate second end 84, the first support 34 folds on and rests parallel to the first longitudinal track 30 in the second position, as shown in FIG. 7. Likewise, the second support 48 may be in the first position with the second extension second end 78 deployed in any one of the grooves 94 located on the second mounting plate 88, other than in the groove 94 closest to the second mounting plate second end 92. FIG. 3 specifically shows the second extension second end 78 deployed in the groove 94 on the second mounting plate 88 closest to the second mounting plate first end 90 with the second support 48 in the first position. With the second extension second end 78 deployed in the groove 94 closest to the second mounting plate second end 92, the second support 48 folds on and rests parallel to the second longitudinal track 32 in the second position, as shown in FIG. 9.

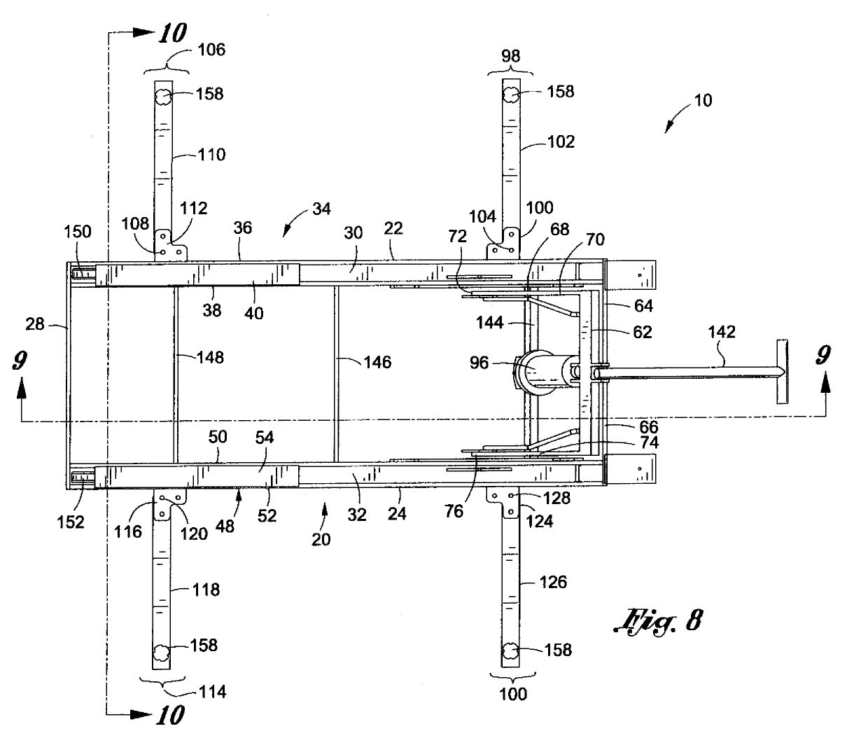

Referring to FIGS. 8-10, the first support 34 and the second support 48 along with the first support primary arm 42 and the second support primary arm 156 are folded on and resting parallel to the first longitudinal track 30 and the second longitudinal track 32, respectively.

What is claimed is:

1. A motorcycle lift for use on a flat surface to lift and support a motorcycle, the motorcycle lift comprising:
a frame including a first longitudinal side and an opposing second longitudinal side, the frame further having a first longitudinal track proximate to and spanning the length of the first longitudinal side, and a second longitudinal track proximate to and spanning the length of the second longitudinal side;
a first support operative to support and lift a motorcycle, the first support having a first support first longitudinal side, an opposing first support second longitudinal side, and a first support top surface disposed between the first support first longitudinal side and the first support second longitudinal side, the first support further having a first support primary arm pivotally connected to the first support, the first support primary arm being further pivotally connected to the first longitudinal track, the first support being disposable in a first position with the first support primary arm at an angle with the first longitudinal side, the first support being further disposable in a second position with the first support primary arm and the first support foldable on and resting parallel to the first longitudinal track;
a second support operative to support and lift a motorcycle, the second support having a second support first longitudinal side, an opposing second support second longitudinal side, and a second support top surface disposed between the second support first longitudinal side and the second support second longitudinal side, the second support further having a second support primary arm pivotally connected to the second support, the second support primary arm being further pivotally connected to the second longitudinal track, the second support being disposable in a first position with the second support primary arm at an angle with the second longitudinal side, the second support being further disposable in a second position with the second support primary arm and the second support foldable on and resting parallel to the second longitudinal track;
a lift arm mechanically connected to the first support and the second support, the lift arm operative to adjust the position of the first support and the second support;
a jack being operatively connected to the lift arm to adjust the height of the lift arm relative to the frame;
a first stabilizing arm assembly, the first stabilizing arm assembly having a first bracket mountable to the first longitudinal side, a first stabilizing arm disposable in the first bracket, and a first bracket hinge mountable to the first bracket operative to adjust the position of the first stabilizing arm, the first stabilizing arm being disposable in a first position parallel to the first longitudinal side, the first stabilizing arm being further disposable in a second position at an angle to the first longitudinal side;
a second stabilizing arm assembly, the second stabilizing arm assembly having a second bracket mountable to the first longitudinal side, a second stabilizing arm disposable in the second bracket, and a second bracket hinge mountable to the second bracket operative to adjust the position of the second stabilizing arm, the second stabilizing arm being disposable in a first position parallel to the first longitudinal side, the second stabilizing arm being further disposable in a second position at an angle to the first longitudinal side;
a third stabilizing arm assembly, the third stabilizing arm assembly having a third bracket mountable to the second longitudinal side, a third stabilizing arm disposable in the third bracket, and a third bracket hinge mountable to the third bracket operative to adjust the position of the third stabilizing arm, the third stabilizing arm being disposable in a first position parallel to the second longitudinal side, the third stabilizing arm being further disposable in a second position at an angle to the second longitudinal side; and
a fourth stabilizing arm assembly, the fourth stabilizing arm assembly having a fourth bracket mountable to the second longitudinal side, a fourth stabilizing arm disposable in the fourth bracket, and a fourth bracket hinge mountable to the fourth bracket operative to adjust the position of the fourth stabilizing arm, the fourth stabilizing arm being disposable in a first position parallel to the second longitudinal side, the fourth stabilizing arm being further disposable in a second position at an angle to the second longitudinal side.

2. The motorcycle lift as claimed in claim 1, the frame having a first lateral side and an opposing second lateral side, the first lateral side and the second lateral side disposed generally between the first longitudinal side and the second longitudinal side.

3. The motorcycle lift as claimed in claim 1, the first support having a first support primary arm first end connectible to the first support, the first support further having a first support primary arm second end connectible to the first longitudinal track.

4. The motorcycle lift as claimed in claim 1, the second support having a second support primary arm first end connectible to the second support, the second support further having a second support primary arm second end connectible to the second longitudinal track.

5. The motorcycle lift as claimed in claim 1, the lift arm having a lift arm first end connectible to the first support operative to adjust the position of the first support, the lift arm further having a lift arm second end connectible to the second support operative to adjust the position of the second support.

6. The motorcycle lift as claimed in claim 1, the jack having a jack first end connectible to the lift arm.

7. The motorcycle lift as claimed in claim 1 further includes a first support secondary arm having a first support secondary arm first end mountable to the first support, the first support secondary arm further having a first support secondary arm second end mountable to the first longitudinal track.

8. The motorcycle lift as claimed in claim 1 further includes a second support secondary arm having a second support secondary arm first end mountable to the second support, the second support secondary arm further having a second support secondary arm second end mountable to the second longitudinal track.

9. The motorcycle lift as claimed in claim 5 further includes a first extension having a first extension first end, the first extension first end being mountable to the lift arm first end;

10. The motorcycle lift as claimed in claim 5 further includes a second extension having a second extension first end, the second extension first end being mountable to the lift arm second end;

11. The motorcycle lift as claimed in claim 9 further includes a first mounting plate having a first mounting plate first end and a first mounting plate second end, the first mounting plate first end being connectible to the first extension second end and the first support primary arm, the first mounting plate second end being connectible to the first extension at a first longitudinal track, the first mounting plate having a plurality of grooves connectible to the first extension second end operative to adjust the position of the first support primary arm;

12. The motorcycle lift as claimed in claim 10 further includes a second mounting plate having a second mounting plate first end and a second mounting plate second end, the second mounting plate first end being connectible to the second extension at a second extension second end and the second support primary arm, the second mounting plate second end being connectible to the second longitudinal track, the second mounting plate having a plurality of grooves connectible to the second extension second end operative to adjust the position of the second support primary arm;

13. The motorcycle lift as claimed in claim 1 further includes a handle mountable to the lift arm operative to pull the motorcycle lift.

14. The motorcycle lift as claimed in claim 1 further includes a first stabilizing crossbar disposable between the first longitudinal track and the second longitudinal track, the jack being mountable to the first stabilizing crossbar at a jack second end.

15. The motorcycle lift as claimed in claim 1 further includes a second stabilizing crossbar disposable between the first longitudinal track and the second longitudinal track.

16. The motorcycle lift as claimed in claim 1 further includes a third stabilizing crossbar disposable between the first longitudinal track and the second longitudinal track.

17. The motorcycle lift as claimed in claim 2 further includes a first longitudinal track wheel disposable in the first longitudinal track proximate to the second lateral side and a second longitudinal track wheel disposable in the second longitudinal track proximate to the second lateral side, the first longitudinal track wheel and the second longitudinal track wheel operative to roll the motorcycle lift on the flat surface.

18. The motorcycle lift as claimed in claim 2 further includes a first rear wheel mountable to the first lateral side and proximate to the first longitudinal track and a second rear wheel mountable to the first lateral side and proximate to the second longitudinal track, the first rear wheel and the second rear wheel operative to roll the motorcycle lift on the flat surface.

19. The motorcycle lift as claimed in claim 1 further includes a stabilizing adjustor disposable on the distal end of each of the first stabilizing arm, the second stabilizing arm, the third stabilizing arm, and the fourth stabilizing arm operative to adjust the position of each of the first stabilizing arm, the second stabilizing arm, the third stabilizing arm, and the fourth stabilizing arm on the flat surface.

20. The motorcycle lift as claimed in claim 1, wherein the jack is a hydraulic jack.

21. The motorcycle lift as claimed in claim 1, wherein the jack is an air over hydraulic jack.
